(19) United States
(12) Patent Application Publication
(10) Pub. No.: US 2026/0081884 A1
(43) Pub. Date: Mar. 19, 2026

(54) INFORMATION PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Wei CAI, Beijing (CN); Chen WANG, Beijing (CN); Ang ZHANG, Beijing (CN); Penglin LI, Beijing (CN); Min ZHANG, Beijing (CN); Qiyang LIU, Beijing (CN); Hui JIA, Beijing (CN); Luobin LI, Beijing (CN)

(21) Appl. No.: 19/107,019

(22) PCT Filed: Sep. 19, 2023
(86) PCT No.: PCT/CN2023/119811

§ 371 Date: Feb. 26, 2025

(30) Foreign Application Priority Data
Sep. 21, 2022 (CN) 202211154194.1

(51) Int. Cl. H04L 51/04; H04L 51/214; H04L 51/216

(52) U.S. Cl. CPC H04L 51/04; H04L 51/214; H04L 51/216

(57) ABSTRACT

The present disclosure provides an information processing method and apparatus, an electronic device, and a storage medium. In some embodiments, the present disclosure provides an information processing method, including: determining at least one target message in response to a first operation event for a message in a first chat, wherein the at least one target message includes a target topic message; wherein the target topic message is a message on which a topic is created in the first chat; and forwarding the at least one target message and related reply information of the target topic message to a second chat in response to a second operation event for the at least one target message.

### CROSS-REFERENCE TO RELATED APPLICATIONS

The present application is based on and claims priority to Chinese Patent Application No. 202211154194.1, filed on Sep. 21, 2022, which is incorporated herein by reference in its entirety.

### TECHNICAL FIELD

The present disclosure relates to the field of computer technologies, and in particular, to an information processing method and apparatus, an electronic device, and a storage medium.

### BACKGROUND

The communication client has a communication function. One communication client may communicate with another communication client in a chat-based manner. During communication, the communication client may forward information in a chat.

### SUMMARY

The present disclosure provides an information processing method and apparatus, an electronic device, and a storage medium.

In some embodiments, the present disclosure provides an information processing method. The method includes:
determining at least one target message in response to a first operation event for a message in a first chat, wherein the at least one target message includes a target topic message, and the target topic message is a message on which a topic is created in the first chat; and
forwarding the at least one target message and related reply information of the target topic message to a second chat in response to a second operation event for the at least one target message.

In some embodiments, the present disclosure provides an information processing apparatus. The apparatus includes:
a determining unit configured to determine at least one target message in response to a first operation event for a message in a first chat, wherein the at least one target message includes a target topic message, and the target topic message is a message on which a topic is created in the first chat; and
a control unit configured to forward the at least one target message and related reply information of the target topic message to a second chat in response to a second operation event for the at least one target message.

In some embodiments, the present disclosure provides an electronic device. The electronic device includes at least one memory and at least one processor, wherein
the memory is configured to store program code, and the processor is configured to call the program code stored in the memory to perform the above method.

In some embodiments, the present disclosure provides a computer-readable storage medium configured to store program code, wherein the program code, when executed by a processor, causes the processor to perform the above method.

In some embodiments, the present disclosure provides a computer program product. The computer program product includes instructions that, when executed by a processor, cause the processor to implement the above method.

In the information processing method provided in this embodiment of the present disclosure, when the target topic message is forwarded, the related reply information of the target topic message is forwarded to the second chat, so that a user in the second chat can view at least some related reply information while viewing the content of the target topic message. In this way, for a forwarder and a receiver of the target message, the content that they can view is similar, thereby avoiding a communication problem caused by different content viewed by the two, and improving a reading experience of the users.

### BRIEF DESCRIPTION OF THE DRAWINGS

The above and other features, advantages, and aspects of the embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an information processing method according to an embodiment of the present disclosure.

FIG. 2 to FIG. 6 are schematic diagrams of interfaces of a communication client according to an embodiment of the present disclosure.

FIG. 7 is a schematic diagram of a structure of an electronic device according to an embodiment of the present disclosure.

### DETAILED DESCRIPTION OF EMBODIMENTS

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed sequentially and/or in parallel. In addition, the method implementations may include additional steps and/or omit the execution of the illustrated steps. The scope of the present disclosure is not limited in this respect.

The term “include/comprise” used herein and variations thereof are an open-ended inclusion, namely, “include/comprise but not limited to”. The term “based on” is “at least partially based on”. The term “an embodiment” means “at least one embodiment”; the term “another embodiment” means “at least one another embodiment”; and the term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” mentioned in the present disclosure are illustrative and not restrictive, and those skilled in the art should understand that unless the context clearly indicates otherwise, it should be understood as “one or more”.

The names of messages or information exchanged between a plurality of apparatuses in the implementations of the present disclosure are used for illustrative purposes only, and are not used to limit the scope of these messages or information.

The solutions provided in the embodiments of the present disclosure will be described in detail below with reference to the accompanying drawings.

The communication client may communicate with another communication client. A chat between the communication clients may be divided into a one-on-one chat and a group chat. In the chat, a communication message sent in the communication client may be a normal communication message or a topic message. When the topic message in the chat is forwarded, the receiver often can only receive the topic message itself, but cannot receive the related reply information of the topic message contained in the chat. That is, when a message to be forwarded includes a topic message, the related reply message of the forwarded topic message is lost, resulting in inconsistency between the messages viewed by the forwarder and the receiver, thereby causing insufficient user experience.

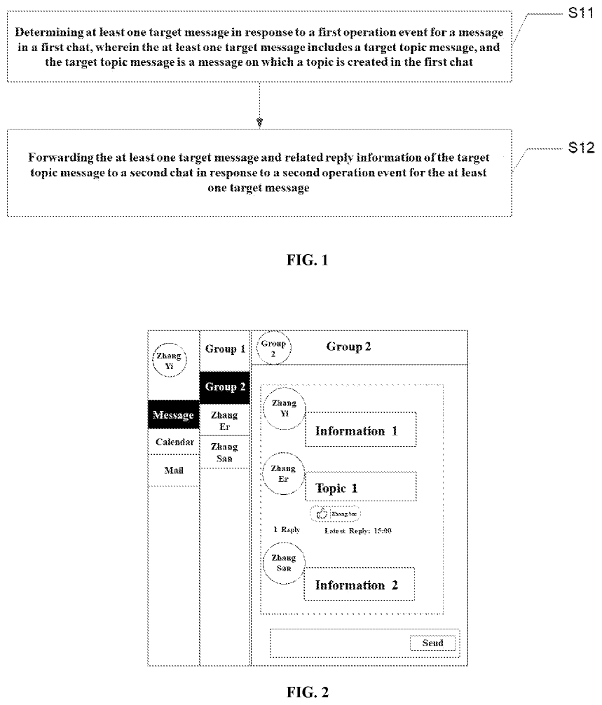

As shown in FIG. 1, FIG. 1 is a flowchart of an information processing method according to an embodiment of the present disclosure. The method includes the following steps.

In S11, at least one target message is determined in response to a first operation event for a message in a first chat, where the at least one target message includes a target topic message, and the target topic message is a message on which a topic is created in the first chat.

In some embodiments of the present disclosure, before the topic is created based on the message, the message is a normal message, that is, the message is not a target topic message yet. After the topic is created based on the message, the message becomes a target topic message, and the message is usually a root message in the topic.

In some embodiments, the information processing method in the embodiments of the present disclosure may be used for a communication client. The communication client may be a client of an independent communication software, or may be a client of a suite software (such as office software including an instant messaging function, a document function, a meeting function, and the like) with an instant messaging function. The first chat may be, for example, a certain one-on-one chat or group chat. The message is interactive information in the first chat, and may be a topic message, a communication message, a document, a picture, a symbol, or the like. The first operation event may be an operation for the message, and the first operation event may be one operation or a combination of a plurality of operations. For example, the first operation event may be a selection operation, and the target message may be a selected message. The number of target messages may be one or at least two. There is a target topic message in the target messages, the target topic message is a topic message, and the topic message is a message on which a topic is created in the first chat. For example, a user sends a message A in a first round, and then a topic is created based on the message A, and the message A becomes a topic message. The target topic message is a topic message in the target messages.

In S12, the at least one target message and related reply information of the target topic message are forwarded to a second chat in response to a second operation event for the at least one target message.

In some embodiments, the second operation event may include one or more operations. For example, the second operation event may be a forwarding operation for the target message. The second chat may be the first chat, or may be another chat different from the first chat. The second chat may be a one-on-one chat or a group chat. When the at least one target message is forwarded to the second chat, the content of the target topic message is forwarded to the second chat, and the related reply information of the target topic message is forwarded to the second chat. In some embodiments, the related reply information of the target topic message may include a topic reply message of the target topic message. Therefore, the second chat will receive the target message itself and the related reply information of the target message, and a user in the second chat can view the related reply information of the target topic message, thereby improving the user experience.

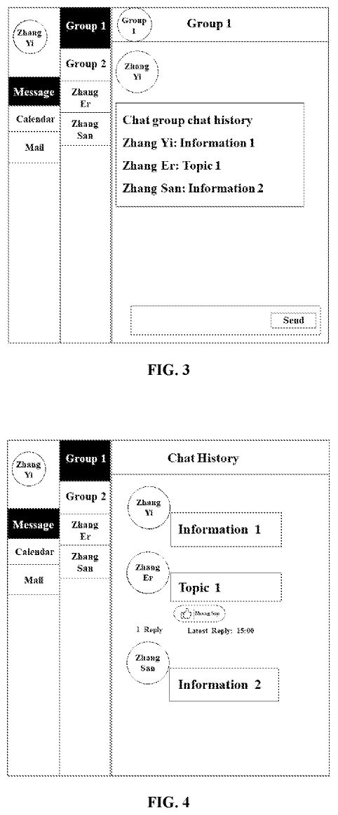

In order to better illustrate the solution proposed in the embodiments of the present disclosure, a specific embodiment is provided below. As shown in FIG. 2, the target messages (information 1, topic 1, and information 2) are selected in the first chat “group 2”, and the three target messages are combined and forwarded to group 1 in FIG. 3. During forwarding, the related reply information such as the topic reply message and the emoji reply information of the topic 1 is also forwarded to group 1. The summary information of the target message is displayed in the group 1, and the summary information is triggered in a manner such as clicking, to display the target message as shown in FIG. 4. As shown in FIG. 4, for the target topic message “topic 1”, not only the content of the target topic message (that is, “topic 1”) is displayed, but also the related reply information such as the emoji reply information and the topic reply message is displayed. It can be seen that when the target topic message is forwarded, the related reply information of the target topic message can be automatically forwarded to the second chat without the user deliberately selecting the related reply information such as the topic reply message and the emoji reply information of the target topic message, so that a user in the second chat can view at least some related reply information while viewing the content of the target topic message. In this way, for a forwarder and a receiver of the target message, the content that they can view at the forwarding moment is similar, thereby avoiding a communication problem caused by different content viewed by the two.

In some embodiments of the present disclosure, the related reply information of the target topic message includes at least one of the following: user information replying to the target topic message, a number of topic reply messages of the target topic message, the topic reply message of the target topic message, operation information of the topic reply message of the target topic message, a latest reply time of the target topic message, and emoji reply information of the target topic message.

In some embodiments, the user information replying to the target topic message may be a user name, an avatar, or the like of a user who posts the topic reply message of the target topic message. The number of topic reply messages of the target topic message may be displayed below the target topic message as shown in FIG. 2. The operation information of the topic reply message of the target topic message may also be, for example, a like for the topic reply message. The latest reply time of the target topic message may be a sending time of a most recent topic reply message. The emoji reply information of the target topic message may include a number of likes for the target topic message, a liker, and the like.

In some embodiments of the present disclosure, the number of target messages is at least two; and the second operation event includes a combined forwarding operation for the at least two target messages. In some embodiments, at least two target messages may be selected, and then combined and forwarded to the second chat, thereby optimizing the reading experience when the topic message is carried in combined forwarding.

In some embodiments of the present disclosure, after the second operation event is detected and before the at least one target message and the related reply information of the target topic message are forwarded to the second chat, the method further includes: displaying a first control, where the first control is used to select whether to hide some of the related reply information; and when it is determined that some of the related reply information is hidden, displaying a second control for selecting content to be hidden in the related reply information. In some embodiments, the user may not expect all related reply information to be forwarded to the second chat, and may expect to hide some of the content. Therefore, the first control may be provided for the target message and the related reply information of the target topic message before being forwarded to the second chat. The first control may be an option control, and the first control may be displayed for the user to select whether to hide some of the related reply information of the target topic message. The hidden part of the related reply information will not be displayed in the second chat. Specifically, the hidden part of the related reply information may not be forwarded to the second chat. In this way, the content that the user does not expect to be forwarded is avoided from being forwarded to the second chat, and the second control is provided to select which related reply information is hidden. The second control may select the part of the related reply information according to the user selection or time, thereby hiding the related reply information of some users or hiding the related reply information within a period of time.

In some embodiments of the present disclosure, after the second operation event is detected and before the at least one target message and the related reply information of the target topic message are forwarded to the second chat, the method further includes: displaying reminder information, where the reminder information is used to notify that the related reply information in the target topic message will be forwarded to the second chat together. In some embodiments, when forwarding, the user may be reminded that the related reply information of the target topic message that is forwarded will be forwarded to the second chat together. In this way, if the user does not expect the related reply information to be forwarded to the second chat, the user may select to stop forwarding, or may select to send only the at least one target message without sending the related reply message.

In some embodiments of the present disclosure, after the at least one target message and the related reply information of the target topic message are forwarded to the second chat, the method further includes: displaying the target message in the second chat, or displaying summary information of the target message in the second chat, and displaying the target message in response to a third operation event for the summary information. In some embodiments, the displaying the target message includes: displaying the target topic message, and displaying at least part of content of the related reply information in an associated area of the target topic message.

In some embodiments, the at least one target message may be forwarded to the second chat in a forwarding-by-item manner or a combined forwarding manner. If the at least one target message is forwarded in the forwarding-by-item manner, the target message may be directly displayed in a chat window of the second chat. If the at least one target message is combined and forwarded, as shown in FIG. 3, the summary information of the target message may be displayed in the chat window of the second chat. The third operation event may be a click operation. The user may trigger the summary information in a manner such as clicking, to display the target message as shown in FIG. 4. There is the target topic message in the displayed target message, and at least part of content of the related reply information is displayed in the associated area of the target topic message “topic 1”. In some embodiments of the present disclosure, the displaying at least part of content of the related reply information in an associated area of the target topic message includes: displaying at least one of the following in the associated area of the target topic message: emoji reply information of the target topic message, a number of topic reply messages of the target topic message, and a latest reply time of the target topic message. As shown in FIG. 4, the associated area of “topic 1” in FIG. 4 shows “1 reply”, “Latest reply: 15:00”, and “Zhang San” likes. In this way, the user in the second chat can learn about the reply to the target topic message.

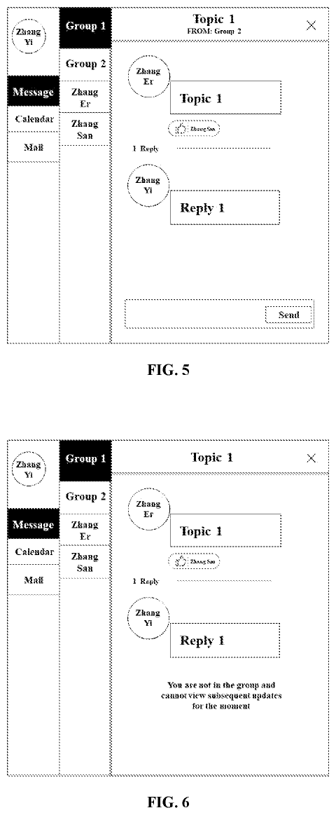

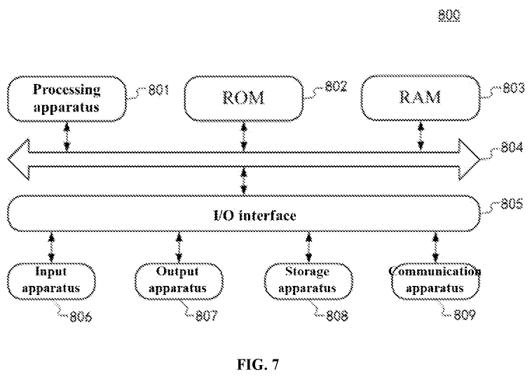

In some embodiments of the present disclosure, the information processing method further includes: displaying a details page of the target topic message in response to a fourth operation event for the target topic message in the second chat. In some embodiments, for example, the fourth operation event may be to trigger the target topic message in the second chat in a manner such as clicking. After the target topic message is triggered, as shown in FIG. 5 and FIG. 6, the details page of the target topic message will be displayed. All related reply information received by the second chat may be displayed in the details page. For example, as shown in FIG. 5, detailed content such as the topic reply message and the replier of the target topic message is displayed, so that the user can learn about related details of the target topic message.

In some embodiments of the present disclosure, the displaying a details page of the target topic message includes: determining information displayed in the details page based on an attribution relationship between a current user who performs the fourth operation event and the first chat. In some embodiments, the current user is a user who opens the details page of the target topic message, and the target topic message is a topic entry in the first chat. Member information of the first chat may be sent to the second chat when the target topic message is forwarded, to determine whether the current user belongs to the first chat. Depending on the attribution relationship, content displayed in the details page of the target topic message may not be completely the same, so that information leakage in the first chat can be avoided. Based on the attribution relationship between the current user and the first chat, a consultable range of the current user may be determined, and data permission of different users is distinguished. Only content for which the current user has data permission is displayed in the details page of the target topic message. In some embodiments, as shown in FIG. 5, if the current user belongs to the first chat, it may be displayed that the target topic message is from the first chat (group 2). Otherwise, as shown in FIG. 6, it may not be displayed that the target topic message is from the first chat, so as to avoid leakage of a specific source of the target topic message.

In some embodiments of the present disclosure, the displaying a details page of the target topic message includes: determining an operation control displayed in the details page based on an attribution relationship between a current user who performs the fourth operation event and the first chat. In some embodiments, an operation permission of the current user may be determined based on the attribution relationship between the current user and the first chat, so that only an operation control for which the current user has an operation permission is displayed in the details page of the target topic message, thereby avoiding a problem that the user performs an operation but the operation cannot be responded to because an operation control for which the current user does not have an operation permission is displayed.

In some embodiments of the present disclosure, the displaying a details page of the target topic message includes: if the current user who performs the fourth operation event belongs to the first chat, displaying the target topic message and a topic reply message of the target topic message as of a current time; or otherwise, displaying the target topic message and a topic reply message of the target topic message as of a forwarding time.

In some embodiments, please refer to FIG. 5 and FIG. 6. FIG. 5 shows a details page of the target topic message displayed when the current user belongs to the first chat, and FIG. 6 shows a details page of the target topic message displayed when the current user does not belong to the first chat. The attribution relationship may be whether the current user is a member of the first chat. In FIG. 5, the details page of the target topic message may be updated in real time. If there is a new topic reply message of the target topic message later, the new topic reply message may be updated and displayed in the details page of the target topic message. In FIG. 6, the displayed details page of the target topic message remains unchanged. Specifically displayed content is related reply information of the target topic message when the target topic message is forwarded to the second chat. If another user replies to the target topic message later, a new topic reply message replied by the other user is not displayed in the details page of the target topic message.

In some embodiments of the present disclosure, the displaying a details page of the target topic message includes: if the current user who performs the fourth operation event belongs to the first chat, displaying a reply control in the details page of the target topic message; or otherwise, not displaying the reply control in the details page of the target topic message.

In some embodiments, please continue to refer to FIG. 5 and FIG. 6. If the current user belongs to the first chat, the current user has permission to reply to the target topic message. Therefore, the reply control is displayed, and a topic reply message can be sent to the target topic message. Because the current user originally belongs to the first chat, the current user can view related content and can participate in the first chat. However, if the current user does not belong to the first chat, the current user cannot reply to the target topic message. Otherwise, it will cause the current user to be able to post information in the first chat without joining the first chat, thereby breaking the permission rule. In some embodiments, as shown in FIG. 6, prompt information may be displayed when the current user does not belong to the first chat to notify the current user that the current user cannot reply and the reason therefor.

In some embodiments of the present disclosure, the displaying a details page of the target topic message includes: if the current user who performs the fourth operation event belongs to the first chat, jumping to a topic discussion interface of the target topic message; or otherwise, displaying a snapshot of a topic discussion interface of the target topic message as of a forwarding time.

In some embodiments, the target topic message is located in the first chat, and the discussion interface of the target topic message may be a details page of the target topic message in the first chat. If the current user belongs to the first chat, the current user has permission to view the first chat, and therefore the topic discussion interface of the target topic message may be directly opened. However, if the current user does not belong to the first chat, only a snapshot of the topic discussion interface of the target topic message as of the forwarding time may be displayed, to prevent the current user from replying. The topic discussion interface of the target topic message may display the target topic message itself, all related reply information, a reply control, a subscription control, and the like.

In some embodiments of the present disclosure, if the current user is not in the first chat, only the target topic message itself and the topic reply message as of the forwarding time can be viewed, and the current user cannot reply; if the current user has joined the first chat, the target topic message, all real-time topic reply messages can be viewed, and the current user can reply.

In some embodiments of the present disclosure, the reading experience of the combined forwarding of the message with the topic entry is optimized, and the attached related reply information can be viewed, ensuring the user experience. Depending on whether the current user belongs to the first chat, different reading permission and operation permission may be presented, thereby meeting the user's reading demands while also controlling the information transmission and information interaction of the chat members within a safe and manageable range, avoiding information leakage, and ensuring the safety and controllability of information.

Some embodiments of the present disclosure further provide an information processing apparatus, including:
a determining unit configured to determine at least one target message in response to a first operation event for a message in a first chat, wherein the at least one target message includes a target topic message, and the target topic message is a message on which a topic is created in the first chat; and
a control unit configured to forward the at least one target message and related reply information of the target topic message to a second chat in response to a second operation event for the at least one target message.

In some embodiments, the related reply information of the target topic message includes at least one of the following:
a topic reply message of the target topic message;
user information replying to the target topic message;
a number of topic reply messages of the target topic message;
operation information of the topic reply message of the target topic message;
a latest reply time of the target topic message; and
emoji reply information of the target topic message.

In some embodiments, the number of target messages is at least two; and
the second operation event is a combined forwarding operation for the at least two target messages.

In some embodiments, the control unit is further configured to: after the at least one target message and the related reply information of the target topic message are forwarded to the second chat, display the target message in the second chat; or display summary information of the target message in the second chat, and display the target message in response to a third operation event for the summary information.

In some embodiments, the displaying the target message includes: displaying the target topic message, and displaying at least part of content of the related reply information in an associated area of the target topic message.

In some embodiments, the displaying at least part of content of the related reply information in an associated area of the target topic message includes:
displaying at least one of the following in the associated area of the target topic message: emoji reply information of the target topic message, a number of topic reply messages of the target topic message, and a latest reply time of the target topic message.

In some embodiments, the control unit is further configured to display a details page of the target topic message in response to a fourth operation event for the target topic message in the second chat.

In some embodiments, the displaying a details page of the target topic message includes:
determining information displayed in the details page based on an attribution relationship between a current user who performs the fourth operation event and the first chat; and/or determining an operation control displayed in the details page based on an attribution relationship between a current user who performs the fourth operation event and the first chat.

In some embodiments, the displaying a details page of the target topic message includes:
if the current user who performs the fourth operation event belongs to the first chat, displaying the target topic message and a topic reply message of the target topic message as of a current time; or otherwise, displaying the target topic message and a topic reply message of the target topic message up to an occurence time of the second operation event; and/or
if the current user who performs the fourth operation event belongs to the first chat, displaying a reply control in the details page of the target topic message; or otherwise, not displaying the reply control in the details page of the target topic message.

In some embodiments, the displaying a details page of the target topic message includes:
if the current user who performs the fourth operation event belongs to the first chat, jumping to a topic discussion interface of the target topic message; or otherwise, displaying a snapshot of a topic discussion interface of the target topic message up to an occurence time of the second operation event.

In some embodiments, the control unit is further configured to perform at least one of the following after the second operation event is detected and before the at least one target message and the related reply information of the target topic message are forwarded to the second chat:
display a first control, wherein the first control is used to select whether to hide some of the related reply information; and when it is determined that some of the related reply information is hidden, display a second control for selecting content to be hidden in the related reply information; and
display reminder information, wherein the reminder information is used to notify that the related reply information in the target topic message will be forwarded to the second chat together. For the embodiment of the apparatus, because it is basically similar to the method embodiment, the relevant part can be referred to the description of the method embodiment. The foregoing described apparatus embodiments are merely illustrative, and the modules described as separate parts may or may not be physically separate. Some or all of the modules may be selected according to actual needs to achieve the objectives of the solutions of the embodiments. Those of ordinary skill in the art may understand and implement the embodiments without creative efforts.

The method and apparatus of the present disclosure are described above based on the embodiments and application examples. In addition, the present disclosure further provides an electronic device and a computer-readable storage medium. The electronic device and the computer-readable storage medium are described below.

Reference is made to FIG. 7 below, which is a schematic diagram of a structure of an electronic device (for example, a terminal device or a server) 800 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV (TV) and a desktop computer. The electronic device shown in the figure is merely an example, and shall not impose any limitation on the function and scope of use of the embodiments of the present disclosure.

The electronic device 800 may include a processing apparatus (for example, a central processing unit, a graphics processing unit, or the like) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 7 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, wherein the computer program includes program code for performing the method shown in the flowchart. In such an embodiment, the computer program may be downloaded from a network through the communication apparatus 809, or installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, an electric, magnetic, optical, electromagnetic, infrared, or semiconductor system, apparatus, or device, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, the client and the server may communicate using any currently known or future-developed network protocol such as the HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device; or may exist independently, without being assembled into the electronic device.

The above computer-readable medium carries one or more programs, and when the one or more programs are executed by the electronic device, the electronic device is caused to perform the method of the present disclosure described above.

The computer program code for performing the operations of the present disclosure may be written in one or more programming languages or a combination thereof, wherein the programming languages include an object-oriented programming language such as Java, Smalltalk, and C++, and further include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to a computer of the user through any kind of network, including a local area network (LAN) or a wide area network (WAN), or may be connected to an external computer (for example, connected through the Internet using an Internet service provider).

The flowcharts and block diagrams in the accompanying drawings illustrate the possible system architectures, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments described in the present disclosure may be implemented by means of software, or may be implemented by means of hardware. The name of a unit does not constitute a limitation on the unit itself in some cases.

The functions described herein above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, the machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, an information processing method is provided, including:
determining at least one target message in response to a first operation event for a message in a first chat, wherein the at least one target message includes a target topic message; wherein the target topic message is a message on which a topic is created in the first chat; and
forwarding the at least one target message and related reply information of the target topic message to a second chat in response to a second operation event for the at least one target message.

According to one or more embodiments of the present disclosure, an information processing method is provided, wherein the related reply information of the target topic message includes at least one of the following:
a topic reply message of the target topic message;
user information replying to the target topic message;
a number of topic reply messages of the target topic message;
operation information of the topic reply message of the target topic message;
a latest reply time of the target topic message; and
emoji reply information of the target topic message.

According to one or more embodiments of the present disclosure, an information processing method is provided, wherein the number of target messages is at least two; and
the second operation event is a combined forwarding operation for the at least two target messages.

According to one or more embodiments of the present disclosure, an information processing method is provided, wherein after the at least one target message and the related reply information of the target topic message are forwarded to the second chat, the method further includes:
displaying the target message in the second chat; or
displaying summary information of the target message in the second chat, and displaying the target message in response to a third operation event for the summary information.

According to one or more embodiments of the present disclosure, an information processing method is provided, wherein the displaying the target message includes: displaying the target topic message, and displaying at least part of content of the related reply information in an associated area of the target topic message.

According to one or more embodiments of the present disclosure, an information processing method is provided, wherein the displaying at least part of content of the related reply information in an associated area of the target topic message includes:
displaying at least one of the following in the associated area of the target topic message: emoji reply information of the target topic message, a number of topic reply messages of the target topic message, and a latest reply time of the target topic message.

According to one or more embodiments of the present disclosure, an information processing method is provided, further including:
displaying a details page of the target topic message in response to a fourth operation event for the target topic message in the second chat.

According to one or more embodiments of the present disclosure, an information processing method is provided, wherein the displaying a details page of the target topic message includes:
determining information displayed in the details page based on an attribution relationship between a current user who performs the fourth operation event and the first chat; and/or
determining an operation control displayed in the details page based on an attribution relationship between a current user who performs the fourth operation event and the first chat.

According to one or more embodiments of the present disclosure, an information processing method is provided, wherein the displaying a details page of the target topic message includes:
if the current user who performs the fourth operation event belongs to the first chat, displaying the target topic message and a topic reply message of the target topic message as of a current time; or otherwise, displaying the target topic message and a topic reply message of the target topic message as of a time when the second operation event occurs; and/or
if the current user who performs the fourth operation event belongs to the first chat, displaying a reply control in the details page of the target topic message; or otherwise, not displaying the reply control in the details page of the target topic message.

According to one or more embodiments of the present disclosure, an information processing method is provided, wherein the displaying a details page of the target topic message includes:
if the current user who performs the fourth operation event belongs to the first chat, jumping to a topic discussion interface of the target topic message; or otherwise, displaying a snapshot of a topic discussion interface of the target topic message as of a time when the second operation event occurs.

According to one or more embodiments of the present disclosure, an information processing method is provided, wherein after the second operation event is detected and before the at least one target message and the related reply information of the target topic message are forwarded to the second chat, the method further includes at least one of the following:
displaying a first control, wherein the first control is used to select whether to hide some of the related reply information; and when it is determined that some of the related reply information is hidden, displaying a second control for selecting content to be hidden in the related reply information; and
displaying reminder information, wherein the reminder information is used to notify that the related reply information in the target topic message will be forwarded to the second chat together.

According to one or more embodiments of the present disclosure, an information processing apparatus is provided, including:
a determining unit configured to determine at least one target message in response to a first operation event for a message in a first chat, wherein the at least one target message includes a target topic message, and the target topic message is a message on which a topic is created in the first chat; and
a control unit configured to forward the at least one target message and related reply information of the target topic message to a second chat in response to a second operation event for the at least one target message.

According to one or more embodiments of the present disclosure, an electronic device is provided, including: at least one memory and at least one processor,
wherein the at least one memory is configured to store program code, and the at least one processor is configured to call the program code stored in the at least one memory to perform the method according to any one of the above.

According to one or more embodiments of the present disclosure, a computer-readable storage medium is provided, wherein the computer-readable storage medium is configured to store program code, and the program code, when executed by a processor, causes the processor to perform the above method.

According to one or more embodiments of the present disclosure, a computer program product is provided, including instructions that, when executed by a processor, cause the processor to implement the above method.

According to one or more embodiments of the present disclosure, a computer program is provided, including instructions that, when executed by a processor, cause the processor to implement the above method.

The above descriptions are merely preferred embodiments of the present disclosure and explanations of the applied technical principles. Persons skilled in the art should understand that the scope of disclosure involved in the present disclosure is not limited to the technical solutions formed by the specific combination of the foregoing technical features, and shall also cover other technical solutions formed by any combination of the foregoing technical features or equivalent features thereof without departing from the above concept of disclosure. For example, a technical solution formed by replacing the foregoing features with technical features with similar functions disclosed in the present disclosure (but not limited thereto).

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in a single embodiment can also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. An information processing method, comprising:
determining at least one target message in response to a first operation event for a message in a first chat, wherein the at least one target message comprises a target topic message; wherein the target topic message is a message on which a topic is created in the first chat; and
forwarding the at least one target message and related reply information of the target topic message to a second chat in response to a second operation event for the at least one target message.

2. The method according to claim 1, wherein the related reply information of the target topic message comprises at least one of the following:
a topic reply message of the target topic message;
user information replying to the target topic message;
a number of topic reply messages of the target topic message;
operation information of the topic reply message of the target topic message;
a latest reply time of the target topic message; and
emoji reply information of the target topic message.

3. The method according to claim 1, wherein
the number of target messages is at least two; and
the second operation event is a combined forwarding operation for at least two of the target messages.

4. The method according to claim 1, wherein after the at least one target message and the related reply information of the target topic message are forwarded to the second chat, the method further comprises:
displaying the target message in the second chat; or
displaying summary information of the target message in the second chat, and displaying the target message in response to a third operation event for the summary information.

5. The method according to claim 4, wherein the displaying the target message comprises: displaying the target topic message, and displaying at least part of content of the related reply information in an associated area of the target topic message.

6. The method according to claim 5, wherein the displaying at least part of content of the related reply information in an associated area of the target topic message comprises:
displaying at least one of the following in the associated area of the target topic message: emoji reply information of the target topic message, a number of topic reply messages of the target topic message, and a latest reply time of the target topic message.

7. The method according to claim 1, further comprising:
displaying a details page of the target topic message in response to a fourth operation event for the target topic message in the second chat.

8. The method according to claim 7, wherein the displaying a details page of the target topic message comprises at least one of the following operations:
determining information displayed in the details page based on an attribution relationship between a current user who performs the fourth operation event and the first chat; and
determining an operation control displayed in the details page based on an attribution relationship between a current user who performs the fourth operation event and the first chat.

9. The method according to claim 7, wherein the displaying a details page of the target topic message comprises at least one of the following operations:
in response that the current user who performs the fourth operation event belongs to the first chat, displaying the target topic message and a topic reply message of the target topic message as of a current time; or otherwise, displaying the target topic message and a topic reply message of the target topic message up to an occurrence time of the second operation event; and
in response that the current user who performs the fourth operation event belongs to the first chat, displaying a reply control in the details page of the target topic message; or otherwise, not displaying the reply control in the details page of the target topic message.

10. The method according to claim 7, wherein the displaying a details page of the target topic message comprises:
in response that the current user who performs the fourth operation event belongs to the first chat, jumping to a topic discussion interface of the target topic message; or otherwise, displaying a snapshot of a topic discussion interface of the target topic message up to an occurence time of the second operation event.

11. The method according to claim 10, wherein after the second operation event is detected and before the at least one target message and the related reply information of the target topic message are forwarded to the second chat, the method further comprises at least one of the following:
displaying a first control, wherein the first control is used to select whether to hide some of the related reply information; and when it is determined that some of the related reply information is hidden, displaying a second control for selecting content to be hidden in the related reply information; and
displaying reminder information, wherein the reminder information is used to notify that the related reply information in the target topic message will be forwarded to the second chat together.

12. (canceled)

13. An electronic device, comprising:
at least one memory and at least one processor,
wherein the at least one memory is configured to store program code, and the at least one processor is configured to call the program code stored in the at least one memory to perform an information processing method, comprising:
determining at least one target message in response to a first operation event for a message in a first chat, wherein the at least one target message includes a target topic message; wherein the target topic message is a message on which a topic is created in the first chat; and
forwarding the at least one target message and related reply information of the target topic message to a second chat in response to a second operation event for the at least one target message.

14. A non-transitory computer-readable storage medium, wherein the computer-readable storage medium is configured to store program code, and the program code, when executed by a processor, causes the processor to perform an information processing method, comprising:
determining at least one target message in response to a first operation event for a message in a first chat, wherein the at least one target message includes a target topic message; wherein the target topic message is a message on which a topic is created in the first chat; and
forwarding the at least one target message and related reply information of the target topic message to a second chat in response to a second operation event for the at least one target message.

15. (canceled)

16. The electronic device according to claim 13, wherein the related reply information of the target topic message comprises at least one of the following:
a topic reply message of the target topic message;
user information replying to the target topic message;
a number of topic reply messages of the target topic message;
operation information of the topic reply message of the target topic message;
a latest reply time of the target topic message; and
emoji reply information of the target topic message.

17. The electronic device according to claim 13, wherein
the number of target messages is at least two; and
the second operation event is a combined forwarding operation for at least two of the target messages.

18. The electronic device according claim 13, wherein after the at least one target message and the related reply information of the target topic message are forwarded to the second chat, the method further comprises:
displaying the target message in the second chat; or
displaying summary information of the target message in the second chat, and displaying the target message in response to a third operation event for the summary information.

19. The electronic device according to claim 18, wherein the displaying the target message comprises: displaying the target topic message, and displaying at least part of content of the related reply information in an associated area of the target topic message.

20. The electronic device according to claim 19, wherein the displaying at least part of content of the related reply information in an associated area of the target topic message comprises:
displaying at least one of the following in the associated area of the target topic message: emoji reply information of the target topic message, a number of topic reply messages of the target topic message, and a latest reply time of the target topic message.

21. The non-transitory computer-readable storage medium according to claim 14, wherein the related reply information of the target topic message comprises at least one of the following:
a topic reply message of the target topic message;
user information replying to the target topic message;
a number of topic reply messages of the target topic message;
operation information of the topic reply message of the target topic message;
a latest reply time of the target topic message; and
emoji reply information of the target topic message.

22. The non-transitory computer-readable storage medium according to claim 14, wherein after the at least one target message and the related reply information of the target topic message are forwarded to the second chat, the method further comprises:
displaying the target message in the second chat; or
displaying summary information of the target message in the second chat, and displaying the target message in response to a third operation event for the summary information.
